(19) United States
(12) Patent Application Publication
(10) Pub. No.: US 2008/0236425 A1
(43) Pub. Date: Oct. 2, 2008

(54) PRINTING PLATE FOR REVERSED RELIEF OFFSET PRINTING, METHOD OF FABRICATING THE SAME, AND METHODS OF FABRICATING SUBSTRATE AND DISPLAY DEVICE

(75) Inventor: Hideaki TAKAMATSU, Kanagawa (JP)

Correspondence Address: YOUNG & THOMPSON, 209 Madison Street, Suite 500, ALEXANDRIA, VA, 22314, US

(73) Assignee: NEC LCD TECHNOLOGIES, LTD, KANAGAWA (JP)

(21) Appl. No.: 12/058,807

(22) Filed: Mar. 31, 2008

(30) Foreign Application Priority Data
Mar. 30, 2007 (JP) 2007-090579

(51) Int. Cl. B41N 1/08

(52) U.S. Cl. 101/453; 101/463.1

(57) ABSTRACT

A printing plate for reversed relief offset printing ensures the prevention of the internal omission of a desired pattern without increasing the depths of depressions of the plate. The printing plate comprises a base material having depressions and a non-depressed part on a surface thereof, and ink repellent layers that cover inner surfaces of the depressions, respectively. The depressions of the base material whose inner surfaces are respectively covered with the ink repellent layers have a plan shape that defines a desired pattern. The non-depressed part of the base material is formed in such a way that a part of an ink film corresponding to the non-depressed part can be transferred to the printing plate in a process of reversed relief offset printing. The parts of the ink film corresponding to the depressions are not transferred to the printing plate due to the repelling action of the ink repellent layers.

### BACKGROUND OF THE INVENTION

1. Field of the Invention

The present invention relates to a printing plate and a method of fabricating the same, a method of fabricating a substrate for a display device, and a method of fabricating a display device. More particularly, the present invention relates to a printing plate for reversed relief offset printing, wherein the inner surfaces of depressions of the printing plate are respectively covered with ink repellent layers; a method of fabricating the plate; a method of fabricating a display device including minute patterns, such as a Liquid-Crystal Display (LCD) device, an organic Electro-Luminescence (EL) display device, a plasma display device, and so on, using the printing plate; and a method of fabricating a substrate to be used for such a display device as described above.

2. Description of the Related Art

In recent years, the LCD device has been extensively used as a high-resolution display device. The LCD device comprises a substrate on which switching elements such as Thin-Film Transistors (TFTs) are formed (which will be termed the “TFT substrate” below), another substrate on which a color filter and a black matrix are formed (which will be termed the “color filter substrate” below), and a liquid crystal layer sandwiched between the TFT substrate and the color filter substrate. An electric field is applied across the pixel electrodes formed on the TFT substrate and the opposite (or common) electrode formed on the color filter substrate, or across the pixel electrodes and the opposite (or common) electrode all of which are formed on the TFT substrate, thereby changing the alignment direction of the liquid crystal molecules in the liquid crystal layer. Thus, the amount of the transmitted light in each pixel is controlled to display desired images.

The above-described electrodes formed on the TFT or color filter substrate and the wiring lines for electrical interconnection between these electrodes have minute shapes formed by patterning. On the other hand, the color filter and the black matrix have comparatively large shapes formed by patterning. Moreover, insulating films are respectively formed these two substrates to cover the whole surfaces thereof.

Conventionally, when the above-described electrodes or lines are formed in the fabrication processes of the TFT or color filter substrate, photolithography and etching methods have ever been used. This is because high dimensional accuracy and high shape accuracy are required for the formation of the above-described electrodes and lines. Recently, however, to reduce the fabrication cost of the LCD device further, the use of a printing method has been developed and proposed instead of the photolithography and etching methods that include complicated processes and that necessitate high-priced apparatuses. This is a method of forming the above-described electrodes and lines using one of the known printing methods.

For example, the Japanese Patent No. 2612492 issued on May 21, 1997 discloses a method of fabricating a color filter substrate using planographic offset printing (see claims 1 to 2 and FIGS. 1 to 3). This method is explained below with reference to FIGS. 1A and 1B.

A prior-art printing plate 100 used in this method comprises a base material 100a, an ink receptive layer 101 having a high affinity for ink to be used in printing (i.e., a high ink affinity or receptivity) formed on a surface of the material 100a, and an ink repellent layer 102 having a high ink repellency formed on the ink receptive layer 101, as shown in FIG. 1A. The ink repellent layer 102 is patterned to have a plan shape corresponding to the pixels of the color filter, where penetrating holes 102a are formed. The ink receptive layer 101 is exposed from the ink repellent layer 102 by way of the holes 102a.

In the fabrication of the color filter substrate of the LCD device using the printing plate 100 having the above-described structure, first, ink of a predetermined color for the pixels of the color filter is coated on the surface of the plate 100. This ink is usually generated by combining a predetermined coloring agent with a synthetic resin. At this time, the ink thus coated is repelled on the ink repellent layer 102 and therefore, it does not remain on the ink repellent layer 102. On the other hand, the ink placed in the holes 102a of the ink repellent layer 102 is left as it is, because the said ink is in contact with the underlying ink receptive layer 101. As a result, an ink film 121 having a plan shape or pattern shown in FIG. 1A is formed on the surface of the plate 100.

Next, a blanket 131 that has been put around the outer surface of a blanket cylinder (not shown) is pressed onto the surface of the printing plate 100 on which the patterned ink film 121 has been formed, and rolled thereon. Then, as shown in FIG. 1b, the patterned ink film 121, which is placed in the respective holes 102a of the plate 100, is transferred to the surface of the blanket 131, resulting in transferred parts 121a on the blanket 131. In this way, the patterned ink film 121 placed on the surface of the plate 100 is transferred in its entirety to the surface of the blanket 131.

Thereafter, the blanket 131 on which the transferred parts 121a of the ink film 121 have been formed is pressed and rolled on the surf ace of a glass plate (not shown) for the color filter substrate on which a patterned light-shielding film (i.e., a black matrix) has been formed, thereby transferring again the transferred parts 121a of the ink film 121 on the blanket 131 to the surface of the said glass plate. As a result, the transferred parts 121a on the blanket 131 are printed onto the positions corresponding to the respective pixels defined by the light-shielding film. At this time, minute protrusions and depressions exist on the surfaces of the transferred parts 121a.

Finally, the blanket 131 is pressed and rolled on the transferred parts 121a of the ink film 121 that have been printed on the surface of the said glass plate, thereby planarizing the surfaces of the parts 121a. In this way, the printing operation of the ink film 121 to the said glass plate is completed.

By repeating the above-described processes for the respective colors required for the fabrication of the color filter, the color filter substrate is obtained, where the printed patterns of desired colors (e.g., three primary colors of red (R), green (G) and blue (B)) have been formed on the surface of the said substrate.

The Japanese Non-Examined Patent Publication No 10-213706 published on Aug. 11, 1998 discloses a method of fabricating a color filter substrate using intaglio offset printing (see claim 3 and paragraphs 0023 to 0033). This method is explained below with reference to FIGS. 2A and 2B.

A prior-art printing plate 110 used in this method comprises a base material 110a, and depressions 110b formed on the surface of the material 110a, where the depressions 110b have in its entirety a plan shape or pattern corresponding to the pixels of the color filter. To facilitate the removal of an ink film, the entire inner surface of each depression 110b is covered with a mold-detaching agent layer 112. The mold-detaching agent layers 112 are formed by coating a mold-detaching agent generated using silicone oil.

In the fabrication of the color filter substrate using the printing plate 110 having the above-described structure, first, the depressions 110b formed on the surface of the plate 110 are selectively filled with ink 120 of a predetermined color for the pixels of the color filter using a squeegee 122. Then, an ink film 121 is formed in the depressions 110b. No ink film is present on the surface of the printing plate 110, i.e., on the part of the surface other than the depressions 110b. The ink film 121 thus formed has a predetermined plan shape or pattern.

Next, a blanket 131 that has been put around the outer surface of a blanket cylinder (not shown) is pressed onto the surface of the printing plate 110 and rolled thereon. Thus, as shown in FIG. 2B, the patterned ink film 121, which is selectively placed in the respective depressions 110b of the plate 110, is transferred to the surface of the blanket 131, resulting in transferred parts 121a on the blanket 131. In this way, the patterned ink film 121 on the surface of the printing plate 110 is transferred in its entirety to the surface of the blanket 131.

Since the inner surface of each depression 110b is covered with the mold-detaching agent layer 112, the ink film 121 embedded in the depressions 110b is easily detached from the depressions 110b and as a result, the entire ink film 121 is transferred to the blanket 131 from the plate 110.

Thereafter, the blanket 131 having the transferred parts 121a of the ink film 121 on its surface is pressed and rolled on the surface of a glass plate (not shown) for the color filter substrate on which a patterned light-shielding film (i.e., a black matrix) has been formed, thereby transferring again the transferred parts 121a of the ink film 121 on the blanket 131 to the surface of the said glass plate. As a result, the transferred parts 121a on the blanket 131 are printed onto the positions corresponding to the respective pixels defined by the light-shielding film. In this way, the printing operation of the ink film 121 to the said glass plate is completed.

By repeating the above-described processes for the respective colors required for the color filter, the color filter substrate where the printed patterns of desired colors (e.g., three colors of R, C and B) have been formed on the surface of the said substrate is obtained.

The Japanese Patent No. 3730002 issued on Oct. 14, 2005 discloses a reversed relief offset printing method (see claims 1 to 6, paragraphs 0007 to 0020, and FIGS. 1 to 5). This method is explained below with reference to FIG. 3.

A prior-art printing plate 120 used in this method comprises a base material 120a, and depressions 123 and a non-depressed part (or, a protruding part) 124 formed on a surface of the material 120a. The non-depressed part 124 is patterned in such a way that the depressions 123 have in its entirety a plan shape corresponding to the pixels of the color filter.

In the fabrication of the color filter substrate using the printing plate 120 having the above-described structure, first, ink of a predetermined color for the pixels of the color filter is coated on the whole surface of a blanket 131 with a coater 133, where the blanket 131 has been put around the outer surface of a transfer cylinder 132. At this time, a uniform ink film 121 is formed on the surface of the blanket 131.

Next, the blanket 131 is pressed onto the surface of the printing plate 100 which has been fixed on a surface plate 150, and rolled thereon. Then, part of the ink film 121 formed on the surface of the blanket 131 is selectively transferred to the ink-receptive non-depressed part 124 of the printing plate 120, resulting in transferred parts 121a on the plate 120. On the other hand, non-transferred parts 121b of the ink film 121 are left on the surface of the blanket 131.

Following this, the blanket 131 on which the non-transferred parts 121b of the ink film 121 have been left is pressed and rolled on the surface of a transparent insulative glass plate 160 for the color filter substrate, where the glass plate 160 has been fixed on the surface plate 150. Then, the non-transferred parts 121b of the ink film 121 placed on the blanket 131 are transferred to the surface of the glass plate 160. In this way, a desired pattern 151 is formed on the surface of the glass plate 160. The desired pattern 151 thus printed is formed by the non-transferred parts 121b. At this time, the ink film 121 does not remain on the surface of the blanket 131.

By repeating the above-described processes for the respective colors required for the color filter, the color filter substrate where the printed patterns 151 of desired colors (e.g., three primary colors of R, G and B) have been formed on the surface of the said substrate in obtained.

The Japanese Non-Examined Patent Publication No. 2005-310405 published on Nov. 4, 2005 discloses a removing plate (which is equivalent to a printing plate) to be used for a reversed relief offset printing (see claims 1 to 3 and FIGS. 1 to 7).

With the prior-art removing or printing plate disclosed in this Publication, the upper surface of the non-depressed part (or, the protruding part) 124 of the printing plate 120 shown in FIG. 3 has been subjected to a drying process, where the contact angle of water on the said upper surface is set at 25° or less. As the drying process, a sandblasting or etching process is shown in this Publication as an example.

According to the explanation of this Publication, by setting the contact angle of water on the upper surface of the non-depressed part 124 is set at 25° or less, wettability of ink to the non-depressed part 124 is enhanced. As a result, when the ink film 121 is transferred from the blanket 131 to the printing plate 120, the ink film 121 can be transferred finely.

With the above-described method of fabricating a color filter substrate disclosed by the Japanese Patent No. 2612492, as explained with reference to FIG. 1, all the ink film 121 formed on the prior-art printing plate 100 is unable to be transferred to the blanket 131 completely. Therefore, a disadvantage that the formation of minute patterns required for the fabrication of the TFT substrate or the like is difficult occurs.

Moreover, since the planarizing process of the surface of the ink film 121 printed on the glass plate for the color filter substrate is necessary, there is another disadvantage that the tact time is long and the mass productivity is poor.

With the above-described method of fabricating a color filter substrate disclosed by the Japanese Non-Examined Patent Publication No. 10-213700, as explained with reference to FIG. 2, the mold-detaching property of the prior-art printing plate 110 varies according to the shape of the depressions 110b. Therefore, there is a problem that this method is difficult to be applied to such a case as the fabrication of the TFT substrate where various patterns need to be formed.

Moreover, there is another problem that when the ink film 121 embedded in the depressions 110b is transferred to the blanket 131, the plan shape and/or the dimensions of the ink film 121 is/are not transferred with good reproducibility.

With the above-described reversed relief offset printing method disclosed by the Japanese Patent No. 3730002, as explained with reference to FIG. 3, there is an advantage that a minute pattern equivalent to that obtained by the photolithography method can be formed and at the same time, the process for planarizing the surface of the printed pattern 151 is unnecessary.

In this method, however, if the area or size of the non-transferred part 121b of the ink film 121 is increased, the area or size of the corresponding depression 123 of the printing plate 120 will increase accordingly. For this reason, when the blanket 131 is pressed and rolled on the surface of the printing plate 120, there is a possibility that the ink film 121 or the blanket 131 is contacted with the inner surface (in particular, the inner bottom surface), of the said depression 123. If so, the ink film 121 formed on the blanket 131 will be transferred not only to the non-depressed part 124 but also to the said depressions 123. This means that a part of the ink film 121, which should be one of the non-transferred parts 121b on the blanket 131 and finally should be a corresponding part of the printed pattern 151, will not be transferred to the glass plate 160 for the color filter substrate.

As a result, there arises a state where the ink film 121 is not present at a corresponding position in the printed pattern 151 to the said non-transferred part 121b (the said one of the non-transferred parts 121b should be present at that position) unintentionally. Such the phenomenon as described here is called the “internal omission”. The state of the “internal omission” is shown in FIGS. 4A, 4B, 5A and 5B.

Here, it is supposed that the desired printed pattern 151 formed by the ink film 121 comprises two pattern elements 151a and 151b formed on the transparent insulative plate 160, as shown in FIGS. 4A and 4B. In this case, however, due to the “internal omission”, the desired printed pattern 151 will be turned to a printed pattern 151′ shown in FIGS. 5A and 5B. As seen from FIGS. 5A and 5B, the pattern element 151a of the printed pattern 151 has a desired plan shape. However, the pattern element 151b′ of the printed pattern 151′ includes au internal omitted part 152 at its central position, which is different from the desired plan shape thereof (i.e., the plan shape of the pattern element 151b shown in FIG. 4A). The phenomenon that causes such the defective pattern element 151b′ is termed the “internal omission”.

To prevent the “internal omission”, it is an idea that the depths of the depressions 123 are increased in such a way that the ink film 121 on the blanket 131 may not be transferred to the depressions 123. If so, however, in the region where the interval between the adjoining elements of the printed pattern 151 (i.e., the adjoining pattern elements) is narrow, these pattern elements are unable to be formed with desired accuracy. This is because glass is usually used for the base material 10a of the printing plate 120 and because the depressions 123 are usually formed by selectively removing the surface of the base material 10a made of glass by wet etching. This is one problem of the reversed relief offset printing method disclosed by the Japanese Patent No. 3730002.

Moreover, if the depths of the depressions 123 are increased, the time required for completing the wet etching process of the base material 120a of the printing plate 120 will be longer accordingly. Therefore, with the reversed relief offset printing method of the Japanese Patent No. 3730002, another problem that the dimensional accuracy of the depressions 123 is likely to deteriorate occurs.

As a result, it is found that the reversed relief offset printing method of the Japanese Patent No. 3730002 is unable to be applied to the fabrication of the TFT substrate of the LCD device that requires the formation of printed patterns more minutely than the color filter substrate thereof with high accuracy.

With the above-described removing plate (i.e., the printing plate) disclosed by the Japanese Non-Examined Patent Publication No. 2005-310405 also, if the area or size of the non-transferred part 121b of the ink film 121 (in other words, if the area or size of the depression 123 of the printing plate 120) is enlarged, the “internal omission” is likely to take place. Accordingly, with the reversed relief offset printing method conducted using the removing or printing plate disclosed by the said Publication also, it is apparent that the same problems as those of the reversed relief offset printing method of the Japanese Patent No. 3730002 (see FIG. 3) will occur.

### SUMMARY OF THE INVENTION

The present invention was created in consideration of the above-described points of the prior-art printing plates and printing methods.

An object of the present invention is to provide a printing plate for reversed relief offset printing that ensures the prevention of the “internal omission” without increasing the depths of depressions, and a method of fabricating the printing plate.

Another object of the present invention is to provide a method of fabricating a substrate for a display device that makes it possible to fabricate a substrate for a display device (e.g., a TFT substrate) that is likely to induce the “internal omission” and that requires the formation of minute printed patterns with high accuracy.

Still another object of the present invention is to provide a method of fabricating a display device that makes it possible to fabricate a display device including a substrate (e.g., a TFT substrate) that is likely to induce the “internal omission” and that requires the formation of minute printed patterns with high accuracy.

The above objects together with others not specifically mentioned will become clear to those skilled in the art from the following description.

According to the first aspect of the present invention, a printing plate is provided, which comprises:

a base material having depressions and a non-depressed part (or a protruding part) on a surface thereof; and

ink repellent layers that cover inner surfaces of the depressions, respectively;

wherein the depressions of the base material whose inner surfaces are respectively covered with the ink repellent layers have a plan shape that defines a desired pattern, and

the non-depressed part of the base material is formed in such a way that a part of an ink film corresponding to the non-depressed part can be transferred to the printing plate in a process of reversed relief offset printing.

With the printing plate according to the first aspect of the present invention, as described above, the depressions and the non-depressed part are formed on the surface of the base material, and the inner surfaces of the depressions are covered with the ink repellent layers, respectively. The depressions of the base material whose inner surfaces are respectively covered with the ink repellent layers have a plan shape that defines a desired pattern. Moreover, in a process of reversed relief offset printing, a part of an ink film corresponding to the non-depressed part (i.e., a part of an ink film which is superposed on the non-depressed part) can be transferred to the printing plate.

Therefore, when an ink film is pressed on the said printing plate to selectively transfer the part of the ink film which is superposed on the non-depressed part (i.e., the part to be transferred) to the printing plate in a process of reversed relief offset printing, the parts of the ink film which are superposed on the depressions (i.e., the parts not to be transferred) are not transferred to the printing plate due to the repelling action of the ink repellent layers, even if the parts superposed on the depressions are contacted with the inner surfaces of the said depressions.

Accordingly, the state where the ink film is not present at a corresponding position in a printed pattern to one of the parts not to be transferred does not occur. This means that the phenomenon termed the “internal omission” is prevented. Moreover, since the inner surfaces of the depressions are respectively covered with the ink repellent layers, the transfer of the parts not to be transferred is surely prevented even if the depths of the depressions are small.

As a result, the prevention of the “internal omission” in the desired pattern is ensured without increasing the depths of the depressions.

In a preferred embodiment of the printing plate according to the first aspect of the invention, the depressions have depths in a range from 2 μm to 0.05 μm. It is more preferred that the depressions have depths in a range from 1 μM to 0.05 μm. In this embodiment, there is an additional advantage that a minute pattern can be printed with high accuracy and high flexibility. The lower limit of the depths of the depressions at 0.05 μm was determined in consideration of the required minimum thicknesses of the ink repellent layers. Specifically, if the depths of the depressions are less than 0.05 μm, there is a possibility that the depressions whose inner surfaces are respectively covered with the ink repellent layers will protrude from the non-depressed part or the surface of the base material.

In another preferred embodiment of the printing plate according to the first aspect of the invention, the base material has an ink affinity and is exposed in the non-depressed part. In this embodiment, there is an additional advantage that the structure of the printing plate is simplified.

In still another preferred embodiment of the printing plate according to the first aspect of the invention, the non-depressed part of the base material is covered with a metal film having an ink affinity. It is usual that the base material is made of glass, where the non-depressed part is made of glass. Since a metal film is usually higher in ink affinity (or ink receptivity) than glass, the ink affinity of the non-depressed part is enhanced by covering it with the metal film. For this reason, the difference of ink repellency between the non-depressed part and the depressions is enlarged. Therefore, in this embodiment, there is an additional advantage that the transfer accuracy of the ink film is improved compared with the case where the non-depressed part of the base material is not covered with any metal film and is left exposed.

In a further preferred embodiment of the printing plate according to the first aspect of the invention, a surface of the non-depressed part of the base material is roughened. In this embodiment, there is an additional advantage that the transfer accuracy of the ink film is improved compared with the case where the surface of the non-depressed part of the base material is not roughened. This is because the ink affinity of the non-depressed part is enhanced due to the surface roughening.

In a further preferred embodiment of the printing plate according to the first aspect of the invention, the ink repellent layers are made of a fluoroplastic such as polytetrafluoroethylene (PTFE), or a silicone resin such as dimethylsiloxane. In this embodiment, there is an additional advantage that the ink repellent layers can be formed easily.

In a further preferred embodiment of the printing plate according to the first aspect of the invention, the ink repellent layers have a surface energy of 18 dyn/cm or lower. In this case, it is preferred that the non-depressed part has a surface energy of 50 dyn/cm or higher. In this embodiment, an additional advantage that the advantages of the present invention are obtained prominently occurs.

According to the second aspect of the present invention, a method of fabricating a printing plate is provided. This is a method of fabricating a printing plate to be used in reversed relief offset printing, which comprises the steps of:

forming a first mask on a surface of a base material;

selectively removing the surface of the base material using the first mask, thereby forming depressions on the surface of the base material;

forming a first layer for ink repellent layers on or over the surface of the base material where the depressions have been formed, the first layer being placed directly on the first mask or over the first mask with intervention of a second mask; and

selectively removing the first layer by removing the first or second mask in such a way that the remaining first layer is placed in the depressions, thereby covering inner surfaces of the depressions with the ink repellent layers, respectively; the ink repellent layers being formed by the remaining first layer;

wherein the depressions of the base material whose inner surfaces are respectively covered with the ink repellent layers have a plan shape that defines a desired pattern.

With the method of fabricating a printing plate according to the second aspect of the present invention, the above-described steps are included and therefore, it is apparent that the printing plate according to the first aspect of the present invention is obtained.

In a preferred embodiment of the method according to the second aspect of the invention, the ink repellent layers are formed directly on the surface of the base material where the depressions have been formed without using the second mask, wherein the first layer is selectively removed by removing the first mask. In this case, the base material is exposed in the non-depressed part.

In another preferred embodiment of the method according to the second aspect of the invention, the ink repellent layers are formed over the surface of the base material where the depressions have been formed with intervention of the second mask, wherein the first layer is selectively removed by removing the second mask. In this case, the non-depressed part is covered with the first mask. It is preferred that the first mask is formed by a metal film, which is due to the following reason. It is usual that the base material is made of glass, where the non-depressed part is made of glass. Since a metal film is usually higher in ink affinity (or ink receptivity) than glass, the ink affinity of the non-depressed part is enhanced by covering it with the metal film.

In still another preferred embodiment of the method according to the second aspect of the invention, the step of roughening the surface of the base material is carried out before the first mask is formed on the surface of the base material.

According to the third aspect of the present invention, a method of fabricating a substrate for a display device is provided, which comprises the step of forming a desired pattern on a member for a display device by a reversed relief offset printing method using the above-described printing plate according to the first aspect of the invention.

With the method of fabricating a substrate for a display device according to the third aspect of the present invention, since the desired pattern is formed on the member for a display device by a reversed relief offset printing method using the above-described printing plate according to the first aspect of the invention, a substrate for a display device (e.g., a TFT substrate) that is likely to induce the “internal omission” and that requires the formation of minute printed patterns with high accuracy can be fabricated without the “internal omission”.

In a preferred embodiment of the method according to the third aspect of the invention, a surface energy E_{REP} of the ink repellent layers, a surface energy E_{PROT} of the non-depressed part (or the protruding part), and a surface energy E_{INK} of an ink used for printing are determined to satisfy a relationship of E_{REP}<E_{INK}<E_{PROT}.

In this case, it is more preferred that E_{REP}, E_{PROT}, and E_{INK} are determined to satisfy the relationships of

E_{REP}≦18 dyn/cm,

20 dyn/cm≦E_{INK}≦24 dyn/cm, and

E_{PROT}≧50 dyn/cm.

In another preferred embodiment of the method according to the third aspect of the invention, a surf ace energy E_{REP} Of the ink repellent layers, a surface energy E_{PROT} of the non-depressed part (or the protruding part), a surface energy E_{INK} of an ink used for printing, and a surface energy E_{BLANKET} of a blanket used for printing are determined to satisfy a relationship of E_{REP}<E_{INK}≦E_{BLANKET}<E_{PROT}.

In this case, it is more preferred that E_{REP}, E_{INK}, E_{BLANKET}, and E_{PROT} are determined to satisfy the relationships of

E_{REP}≦18 dyn/cm,

20 dyn/cm≦E_{INK}≦24 dyn/cm,

18 dyn/cm≦E_{BLANKET}≦30 dyn/cm, and

E_{PROT}≧50 dyn/cm.

In still another preferred embodiment of the method according to the third aspect of the invention, a surface energy E_{REP} of the ink repellent layers, a surface energy E_{PROT} of the non-depressed part (or the protruding part), a surface energy E_{INK} of an ink used for printing, and a surface energy E_{PLATE} of the member (e.g., a glass plate) for a display device on which the printed pattern is to be formed are determined to satisfy a relationship of E_{REP}<E_{INK}≦E_{BLANKET}<E_{PLATE}.

In this case, it is more preferred that E_{REP}, E_{INK}, and E_{BLANKET} are determined to satisfy the relationships of

E_{REP}≦18 dyn/cm,

20 dyn/cm≦E_{INK}≦24 dyn/cm, and

18 dyn/cm≦E_{BLANKET}≦30 dyn/cm.

In a further preferred embodiment of the method according to the third aspect of the invention, a patterned mask is formed on the member for a display device by reversed relief offset printing using ink containing a resist material.

In a still further preferred embodiment of the method according to the third aspect of the invention, a patterned conductive film is formed on the member for a display device by reversed relief offset printing using ink containing a conductive fine powder.

In a still further preferred embodiment of the method according to the third aspect of the invention, a patterned insulative film is formed on the member for a display device by reversed relief offset printing using ink containing an insulative resin.

According to the fourth aspect of the present invention, a method of fabricating a display device is provided, which comprises the step of forming a desired pattern on a substrate for a display device by a reversed relief offset printing method using the above-described printing plate according to the first aspect of the invention.

With the method of fabricating a display device according to the fourth aspect of the present invention, since the step of forming a desired pattern on the substrate for a display device by a reversed relief offset printing method using the above-described printing plate according to the first aspect of the invention is included, a substrate for a display device (e.g., a TFT substrate) that is likely to induce the “internal omission” and that requires the formation of minute printed patterns with high accuracy can be fabricated without the “internal omission”. Therefore, by using the substrate for a display device thus fabricated, a display device can be fabricated without the “internal omission”.

### BRIEF DESCRIPTION OF THE DRAWINGS

In order that the present invention may be readily carried into effect, it will now be described with reference to the accompanying drawings.

FIGS. 1A and 1B are conceptual views showing a prior-art method of fabricating a color filter substrate using planographic offset printing, respectively.

FIGS. 2A and 2B are conceptual views showing a prior-art method of fabricating a color filter substrate using intaglio offset printing, respectively.

FIG. 3 is a conceptual view showing a prior-art method of fabricating a color filter substrate using a reversed relief offset printing method.

FIG. 4A is a plan view of a desired printed pattern formed on a transparent insulative plate for a color filter substrate by a prior-art method of fabricating a color filter substrate using a reversed relief offset printing method.

FIG. 4B is a cross-sectional view along the line IVB-IVB in FIG. 4A.

FIG. 5A is a plan view of a defective printed pattern formed on a transparent insulative plate for a color filter substrate by a prior-art method of fabricating a color filter substrate using a reversed relief offset printing method, where the printed pattern includes an internal omitted part.

FIG. 5B is a cross-sectional view along the line VB-VB in FIG. 5A.

FIG. 6 is a schematic partial cross-sectional view showing the structure of a printing plate for reversed relief offset printing according to a first embodiment of the present invention.

FIGS. 7A to 7C are schematic partial cross-sectional views showing the transferring status of an ink film to a printing plate from a blanket in the case where reversed relief offset printing is carried out using the printing plate according to the first embodiment of the present invention, respectively.

FIGS. 8A to 8C are schematic partial cross-sectional views showing the process steps of a method of fabricating the printing plate according to the first embodiment of the present invention, respectively.

FIGS. 9A and 9B are schematic partial cross-sectional views showing the process steps of the method of fabricating the printing plate according to the first embodiment of the present invention, respectively, which is subsequent to FIG. 8C.

FIG. 10 is a conceptual view showing a method of fabricating a substrate (i.e., a TFT substrate) for a display device by a reversed relief offset printing method using the printing plate according to the first embodiment of the present invention.

FIG. 11 is a graph showing the relationship between the depth or height x of the depressions of the printing plate according to the first embodiment of the present invention and the printable line width y at the depth or height x.

FIGS. 12A to 12C are schematic partial cross-sectional views showing the process steps of a method of fabricating a printing plate according to a second embodiment of the present invention, respectively.

FIGS. 13A and 13B are schematic partial cross-sectional views showing the process steps of the method of fabricating the printing plate according to the second embodiment of the present invention, respectively, which is subsequent to FIG. 12C.

FIGS. 14A to 14C are schematic partial cross-sectional views showing the process steps of a method of fabricating a printing plate according to a third embodiment of the present invention, respectively.

FIGS. 15A to 15C are schematic partial cross-sectional views showing the process steps of the method of fabricating the printing plate according to the third embodiment of the present invention, respectively, which is subsequent to FIG. 14C.

FIG. 16 is a schematic partial cross-sectional view showing the process step of the method of fabricating the printing plate according to the third embodiment of the present invention, which is subsequent to FIG. 15C.

FIG. 17A is a schematic plan view showing the structure of a LCD device, in which both of the TFT substrate and the color filter substrate are fabricated by the method according to the first, second, or third embodiment of the present invention.

FIG. 17B is a schematic enlarged cross-sectional view of the region A in the LCD device of FIG. 17A.

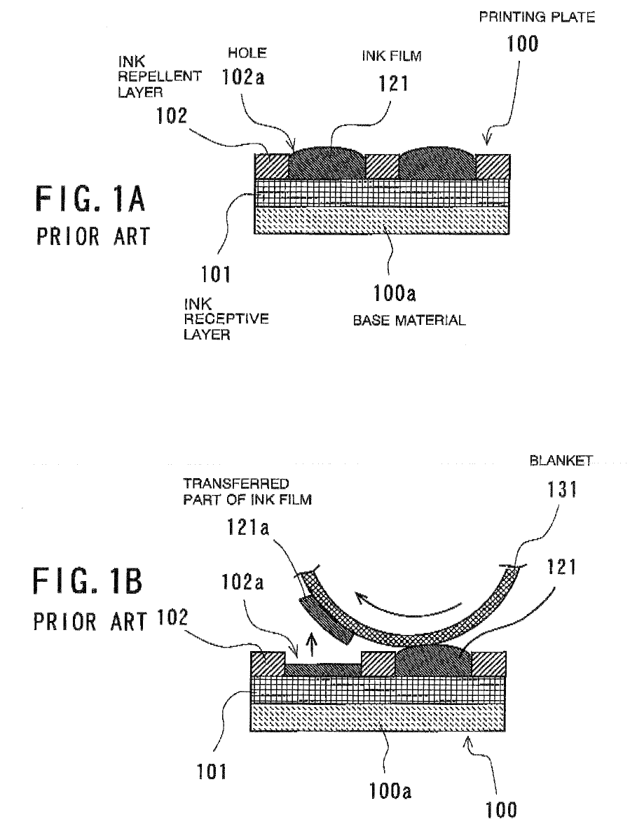

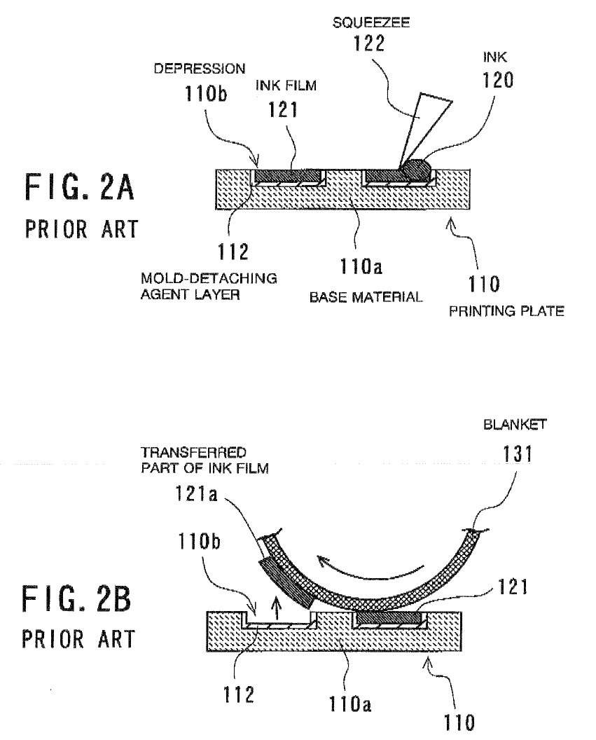

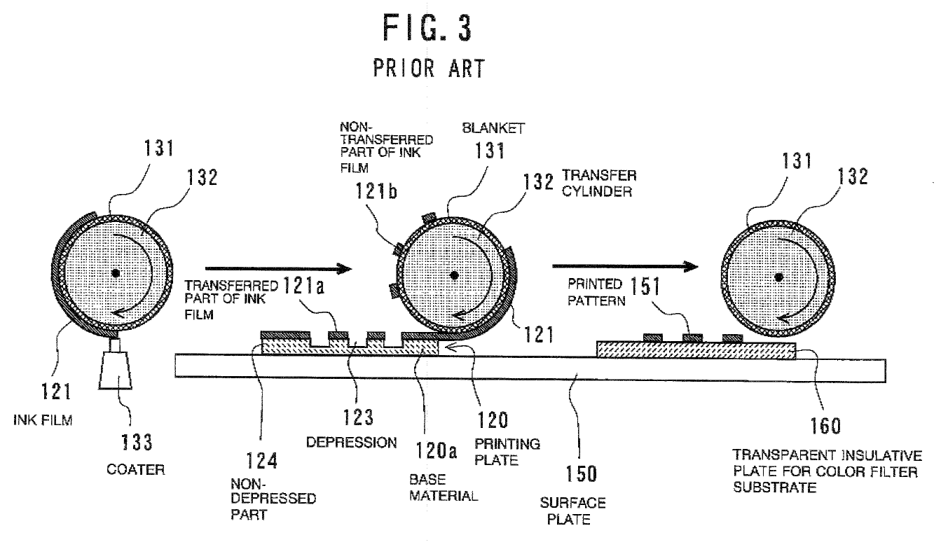

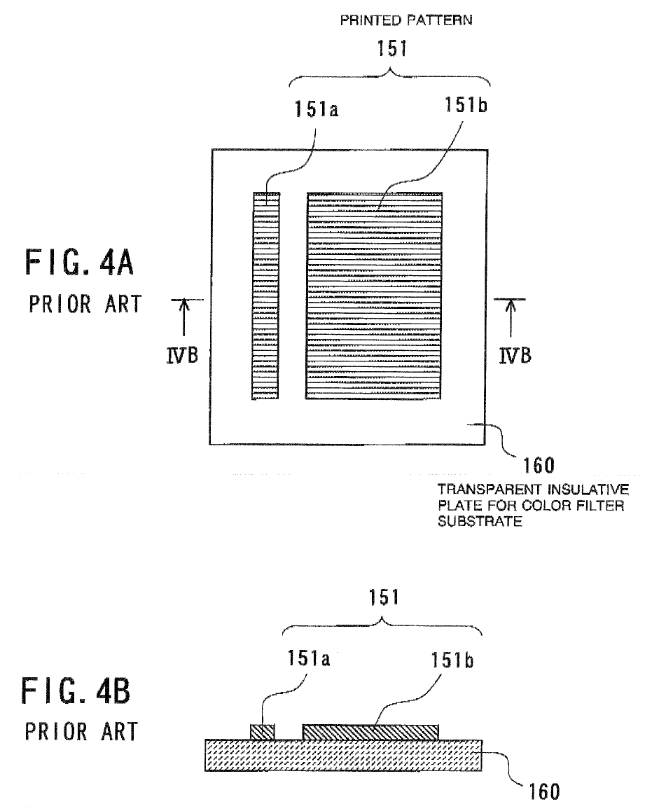

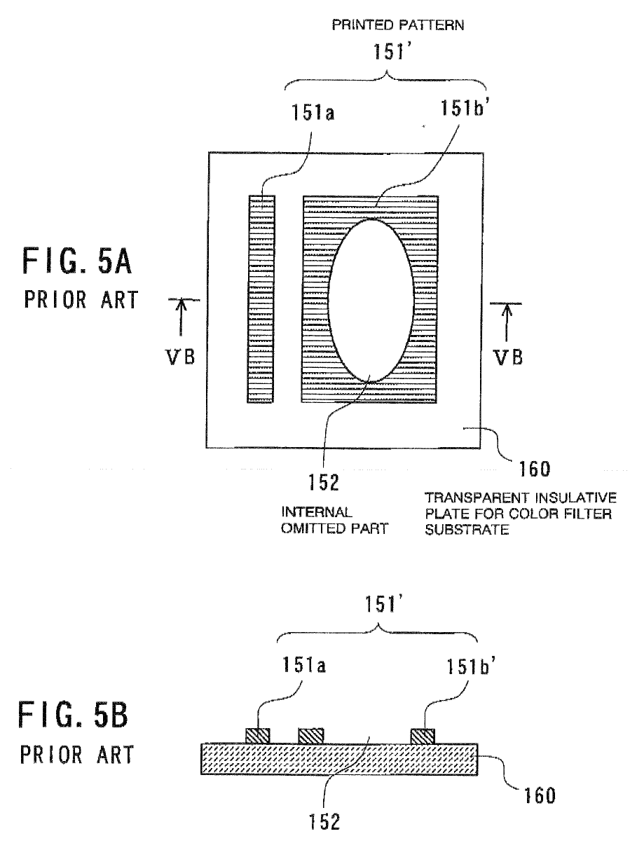

### DETAILED DESCRIPTION OF THE PREFERRED EMBODIMENTS

Preferred embodiments of the present invention will, be described in detail below while referring to the drawings attached.

### First Embodiment

### Structure of Printing Plate

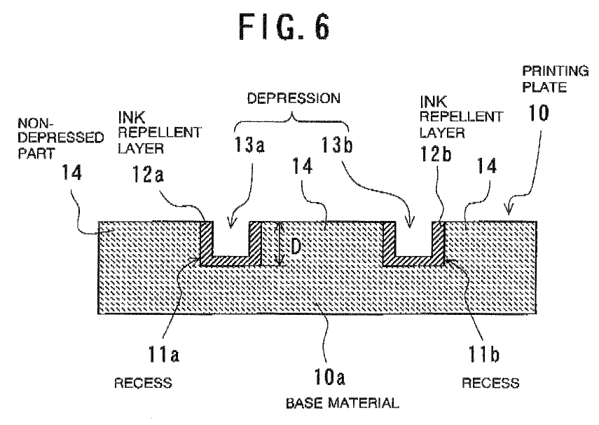

The schematic structure of a printing plate 10 for reversed relief offset printing according to a first embodiment of the present invention is shown in FIG. 6.

As shown in FIG. 6, the printing plate 10 according to the first embodiment comprises a plate-shaped base material 10a having recesses 11a and 11b on its surface, and ink repellent layers 12a and 12b formed respectively on the inner surfaces of the recesses 11a and 11b. The entire inner surfaces of the recesses 11a and 11b are covered with the ink repellent layers 12a and 12b, respectively. As a result, depressions 13a and 13b are formed on the surface of the base material 10a. The depression 13a is defined by the recess 11a and the ink repellent layer 12a. The depression 13b is defined by the recess 11b and the ink repellent layer 12b. The part of the plate 10 other than the depressions 13a and 13b is a non-depressed part 14. The non-depressed part 14 may be termed a protruding part because this part 14 is protruding with respect to the depressions 13a and 13b. In the non-depressed part 14, the base material 10a is exposed as it is.

Practically, the printing plate 10 comprises other recesses (not shown) similar to the recesses 11a and 11b, and the entire inner surfaces of these recesses are covered with other ink repellent layers similar to the ink repellent layers 12a and 12b, respectively. The recesses 11a and 11b and the other recesses (not shown), and the ink represent layers 12a and 12b and the other ink repellent layers (not shown) (in other words, the depressions 13a and 13b and other depressions (not shown)) are formed in such a way as to define a desired pattern to be printed. However, to simplify the illustration and explanation, only the two recesses 11a and 11b and the two ink repellent layers 12a and 12b (in other words, only the two depressions 13a and 13b) are shown here.

The base material 100a of the printing plate 10 is made of a material having a good flatness and a good ink affinity (or a good ink receptivity) for ink to be used for printing. For example, soda lime, alkali-free glass, quartz, or the like may be used for the base material 10a. However, it is preferred that quartz glass is used for this purpose. This is because quartz glass has an excellent flatness and a high ink affinity.

As the material for the ink repellent layers 12a and 12b (i.e., the ink repellent material), any material may be used if it has ink repellency for ink to be used for printing. However, it is preferred that a fluororesin such as polytetrafluoroethylene (PTFE), or a silicone resin such as dimethylsiloxane is used for this purpose. It is more preferred that a fluororesin made of PTFE, which is designed for coating, is used.

The printing plate 10 according to the first embodiment of the present invention has the above-described structure and therefore, the non-depressed part 14, where the base material 10a of the plate 10 is exposed as it is, is ink receptive for the ink to be used for printing. Moreover, the inner surface of the depression 13a which is covered with the ink repellent layer 12a and the inner surface of the depression 13b which is covered with the ink repellent layer 12b are ink repellent for the ink to be used for printing. Therefore, when the film of the ink (i.e., the ink film) (not shown) to be used for printing is contacted with the surface of the plate 10, the part of the ink film contacted with the non-depressed part 14 is transferred to the surface of the plate 10. However, the parts of the ink film corresponding to the depressions 13a and 13b (i.e., the ink repellent layers 12a and 12b) are not contacted with the surface of the plate 10 and therefore, they are not transferred to the surface of the plate 10.

Even if the ink film is pressed into the insides of the depressions 13a and 13b to be in contact with the ink repellent layers 12a and 12b, the ink film is repelled by the ink repellent layers 12a and 12b. Accordingly, there is no possibility that the ink film is unintentionally transferred to the depressions 13a and 13b to become a cause of the “internal omission”.

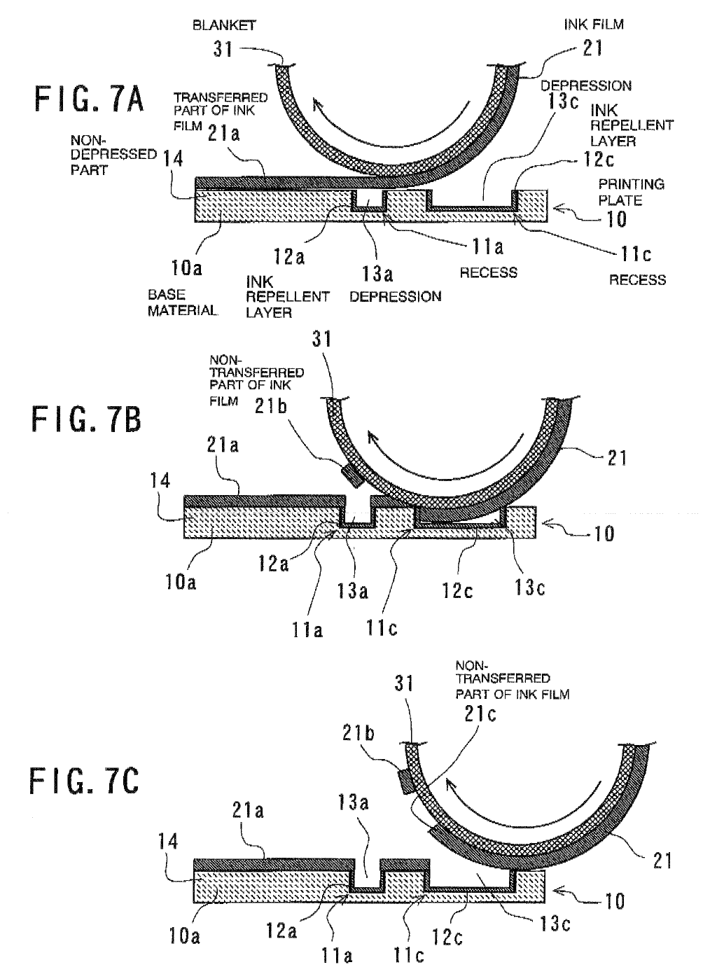

This point is explained with reference to FIGS. 7A to 7C below. FIGS. 7A to 7C are schematic partial cross-sectional views showing the transferring status of the ink film to the printing plate 10 in the case where reversed relief offset printing is carried out using the printing plate 10, respectively.

The structure of the printing plate 10 of FIG. 7A is approximately the same as that of the printing plate 10 of FIG. 6; however, the structures of the depressions are slightly different. Specifically, the depression 13a located on the left side of FIG. 7A is the same in structure as the depression 13a located on the left side of FIG. 6, where the depression 13a has a size such that the ink film and the blanket are not in contact with the bottom of the depression 13a. On the other hand, the depression 13c located on the right side of FIG. 7A is different in structure from the depression 13b located on the right side of FIG. 6. The depression 13c has an area or size considerably wider than the depressions 13a and 13b and has a size such that the ink film and the blanket can be in contact with the bottom of the depression 13c. The entire inner surface of the depression 13c is covered with the ink repellent layer 12c similar to the depressions 13a and 13b. The ink repellent layer 12c is made of the same material as the ink repellent layers 12a and 12b.

First, as shown in FIG. 7A, the ink film 21 formed on the outer surface of the cylindrical blanket 31 is pressed on the surface of the printing plate 10 and rolled thereon. When the blanket 31 reaches the position where the lowest edge of the blanket 31 is superposed on the depression 13a, the part of the ink film 21 in contact with the non-depressed part 14 is transferred to the non-depressed part 14. This is because the non-depressed part 14 has an ink receptive property. However, the part of the ink film 21 placed over the depression 13a is not transferred. This is because the area or size of the depression 13a is sufficiently narrower than the radius of curvature of the ink film 21 (i.e., the blanket 31) and therefore, the ink film 21 does not enter the inside of the depression 13a. The said part of the ink film 21 is left on the blanket 31 as a non-transferred part 21b (see FIG. 73).

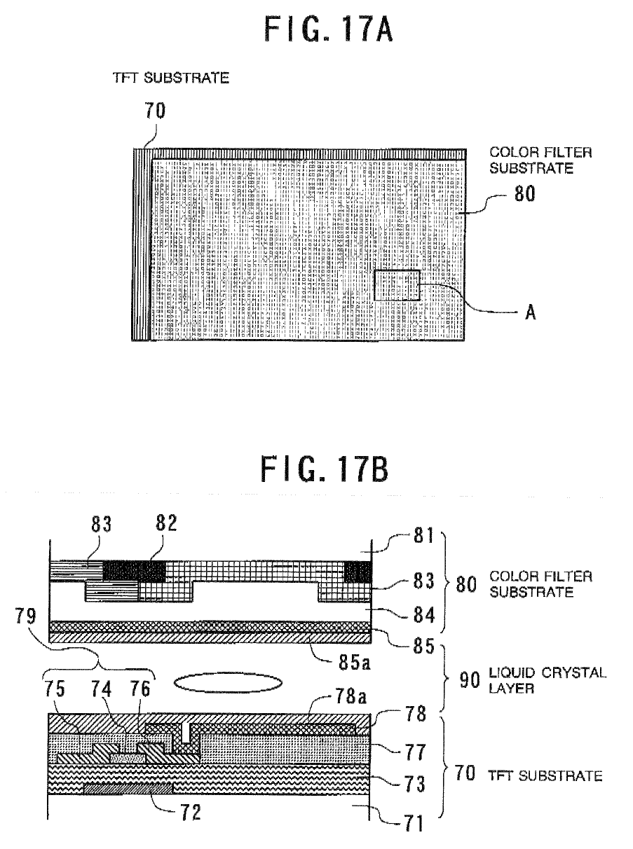

Next, as shown in FIG. 17B, when the blanket 31 reaches the position where the lowest edge of the blanket 31 is superposed on the depression 13c, the part of the ink film 21 in contact with the non-depressed part 14 between the depressions 13a and 13c is transferred to the non-depressed part 14. However, the part of the ink film 21 placed over the depression 13c is not transferred although the said part enters the inside of the depression 13c and is contacted with the inner surface thereof. This is because the entire inner surface of the depression 13c is covered with the ink repellent layer 12c. As a result, as shown in FIG. 7C, the part of the ink film 21 located over the depression 13c is left on the blanket 21 as a non-transferred part 21c.

With the printing plate 10 according to the first embodiment of the invention, as apparent from the above explanation, even if the printing plate 10 comprises the depression 13c having an area or size and a depth such that the ink film 21 or the blanket 31 can be contacted with the inner surface of the depression 13c, the “internal omission” is prevented surely without increasing the depth of the depression 13c. As a result, the desired printed pattern can be obtained surely by the ink film 21 selectively left on the blanket 31.

### Method of Fabricating Printing Plate

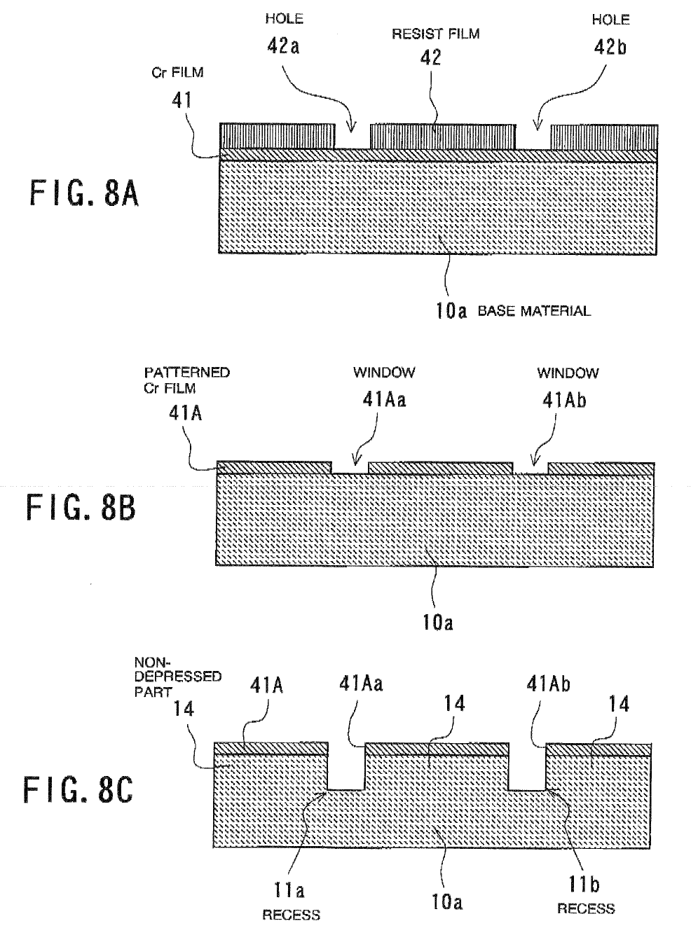

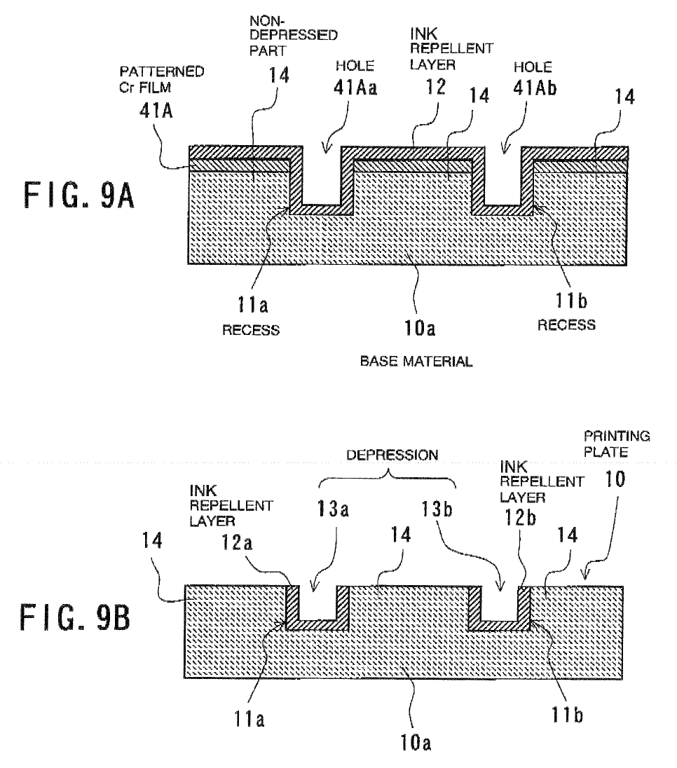

Next, a method of fabricating the printing plate 10 according to the first embodiment is explained below with reference to FIGS. 8A to 8C and FIGS. 9A and 9B. FIGS. 8A to 8C and 9A and 9B are schematic partial cross-sectional views showing the process steps of this method, respectively.

First, a chromium (Cr) film 41 is formed on the surface of the plate-shaped base material 10a by a known method. For example, the evaporation or sputtering method may be used for this process.

Next, a resist film 42 is formed on the Cr film 41 and thereafter, the resist film 42 is patterned by a known method. The formation of the resist film 42 may be carried out by any method, such as the spill coating, slit coating, roll coating, or spraying method, if the uniform resist film 42 is obtained by it. The patterning of the resist film 42 may be carried out by the photolithography, electron-beam lithography, laser direct writing method, or the like. As a result, penetrating holes 42a and 42b are formed in the resist film 42. The state at this stage is shown in FIG. 8A. The plan shapes of the holes 42a and 42b, which are determined in accordance with the desired pattern to be printed, may be rectangular, belt-like, or the like.

Next, the Cr film 41 is selectively etched using the patterned resist film 42 as a mask (a first mask). Thus, windows 41Aa and 41Ab are formed in the Cr film 41, as shown in FIG. 8B. It is preferred that the etching of the Cr film 41 is carried out by wet etching. In this way, a patterned Cr film 41A is obtained. The patterned Cr film 41A is used as a mask in the etching process of the base material 10a. The windows 41Aa and 41Ab of the Cr film 41A are located at the positions right below the holes 42a and 42b of the resist film 42, respectively. After the etching process of the Cr film 41 is completed, the resist film 42 is removed.

Subsequently, the surface of the base material 10a is selectively etched using the patterned Cr film 41A as a mask, thereby forming recesses 11a and 11b each having a predetermined depth, as shown in FIG. 8C. It is preferred that the etching of the base material 10a is carried out by wet etching. The plan shapes of the recesses 11a and 11b are approximately the same as those of the holes 42a and 42b, respectively.

Next, an ink repellent layer 12 is formed on the patterned Cr film 41A to cover the surface of the base material 10a having the recesses 11a and 11b. At this time, as shown in FIG. 9A, the surface of the Cr film 41A, the inner surfaces (inner bottoms and inner sides) of the recesses 11a and 11b, and the end faces of the Cr film 41A exposed laterally toward the recesses 11a and 11b are covered with the ink repellent layer 12.

The ink repellent layer 12 can be easily formed. For example, a fluororesin made of PTFE, a silicone resin such as dimethylsiloxane, or the like is dissolved in an appropriate solvent and thereafter, it is applied to the Cr film 41A by coating, spraying or the like and then, dried. In this way, the ink repellent layer 12 can be easily obtained.

As the ink repellent material for the ink repellent layer 12, it is preferred that the surface energy E_{REP} Of the ink repellent material after drying (i.e., the surface energy of the ink repellent layer 12) is less than the surface energy E_{INK} of the ink used for printing. In other words, it is preferred that an ink repellent material satisfying the relationship of E_{REP}<E_{INK} is used. This is because if the relationship of E_{REP}<E_{INK} is satisfied, desired ink repellency (desired ink repelling function) effective for preventing the transfer of the ink film is obtained.

It is necessary that the surface energy E_{PROT} of the non-depressed part (i.e., the protruding part) 14 is greater than the surface energy E_{INK} of the ink. Therefore, the relationship of E_{REP}<E_{INK}<E_{PROT} needs to be satisfied.

Moreover, it is more preferred that the surface energy E_{REP} of the ink repellent layer 12 is equal to or less than 18 dyn/cm. In other words, it is more preferred that an ink repellent material satisfying the relationship of E_{REP}≦18 dyn/cm is used. This is because if the ink repellent material satisfies the relationship of E_{REP}≦18 dyn/cm, the relationship of E_{REP}<E_{INK} can be satisfied between the ink repellent layer 12 and various inks to be used in the fabrication of the TFT substrate or the color filter substrate. If so, desired ink repellency effective for preventing the transfer of the ink film can be easily obtained in the fabrication processes of the TFT substrate or the color filter substrate.

As a concrete example, the ink repellent material named “Novec EGC-1720” produced by Sumitomo 3M Limited is preferably used for this purpose. It was found by the inventor that the surface energy E_{REP} of Novec EGC-1720 after drying was 13 dyn/cm and that excellent ink repellency for the ink repellent layer 12 was observed.

Finally, the Cr film 41A in the state of FIG. 9A is removed or detached and as a result, the part of the ink repellent layer 12 placed on the Cr film 41A is removed along with the Cr film 41A. At the same time, only the parts 12a and 12b of the ink repellent layer 12 existing in the recesses 11a and 11b are left as they are. For this reason, as shown in FIG. 9B, only the inner surfaces of the recesses 11a and 11b of the base material 10a are respectively covered with the ink repellent layers 12a and, 12b while the base material 10a is exposed in the region other than the recesses 11a and 11b (i.e., in the non-depressed part 14). The ink repellent layers 12a and 12b correspond to the remaining parts 12a and 12b of the ink repellent layer 12, respectively. At this time, the depressions 13a and 13b are formed on the surface of the base material 10a by the recesses 11a and 11b whose inner surfaces are respectively covered with the ink repellent layers 12a and 12b. In this way, the printing plate 10 according to the first embodiment is fabricated.

### Method of Fabricating Substrate for Display Device

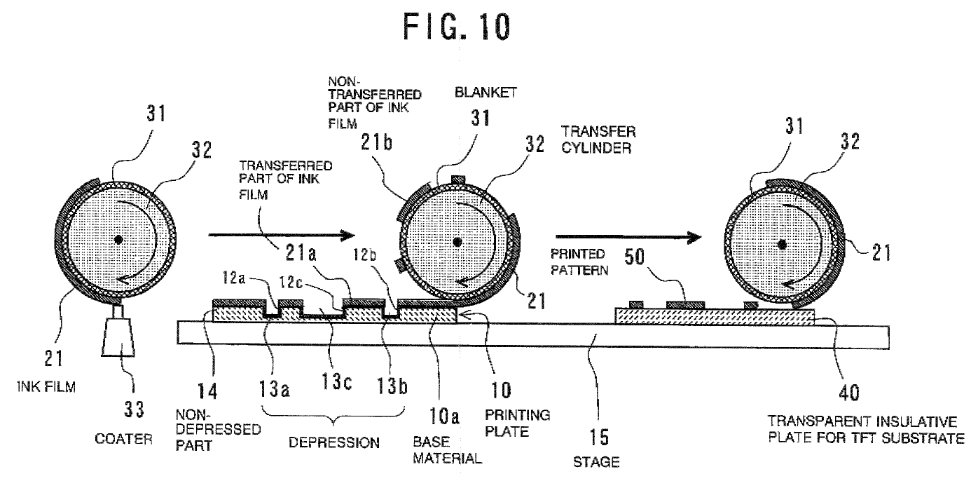

Next, a method of fabricating a substrate for a display device by the reversed relief offset printing method using the printing plate 10 according to the first embodiment is explained below with reference to FIG. 10. FIG. 10 is a conceptual view showing this method, where a TFT substrate for a LCD device is fabricated.

As shown in FIG. 10, the printing plate 10 is mounted on a horizontal stage 15 in the state where the surface of the plate 10 is upward. Therefore, the depressions 13a and 13b each having a narrow area or size, the depression 13c having a wide area or size, and the non-depressed part 14 formed in the region other than the depressions 13a, 13b and 13c are all faced upward.

A transparent insulative plate 40 for a TFT substrate (e.g., a glass plate) is fixed on the stage 15 apart from the printing plate 10 at a predetermined distance. The face (surface) of the plate 40 where TFTs are to be formed is also upward. The plate 40 may be a rigid plate or a flexible film-shaped plate.

A transfer cylinder 32 on which a blanket 31 has been put around is movable in the horizontal direction along the stage 15. A coater 33 is provided outside the stage 15.

In FIG. 10, only the transfer cylinder 32, the blanket 31, and the coater 33 of a reversed relief offset printing machine used here are shown. This is because the transfer cylinder 32, the blanket 31, and the coater 33 of this printing machine are concerned with the present invention. Since the structure of this printing machine is known, the detailed structure of this machine (including the transfer cylinder 32 and the blanket 31) is omitted here.

First, ink for printing is coated with the coater 33 on the surface of the blanket 31 put around the outer surface of the transfer cylinder 32. As a result, an ink film 21 with a predetermined thickness is formed on the surface of the blanket 31. The ink film 21 may be formed on the entire surface of the blanket 31 or a part of the said surface. Any method may be used for the formation of the ink film 21 on the surface of the blanket 31 if the ink film 21 can be formed to have a uniform thickness by it. The invention is not limited to the formation method using the coater 33. For example, a spin coating method may be used for this purpose.

As the material for the blanket 31 (i.e., a blanket material), it is preferred to use a blanket material having a low surface energy. Concretely speaking, when the surface energy of the blanket material is defined as E_{BLANKET}, it is preferred for the blanket material to satisfy the relationship of 18 dyn/cm≦E_{BLANKET}≦30 dyn/cm. It is more preferred for the blanket material to satisfy the relationship of 18 dyn/cm≦E_{BLANKET}≦24 dyn/cm.

On the other hand, it is preferred for the surface energy E_{INK} Of the ink to satisfy the relationship of 20 dyn/cm≦E_{INK}≦24 dyn/cm. The surface energy E_{INK} of the ink is adjusted within this range in such a way that the ink is not repelled by the blanket 31 and that the ink is placed on the blanket to form the ink film 21 as desired.

It is preferred that the surface energy E_{REP} of the ink repellent layers 12a, 12b and 12c satisfies the relationship of E_{REP}≦18 dyn/cm. It is preferred that the surface energy E_{PROT} Of the non-depressed part 14 (i.e. the base material 10a) satisfies the relationship of E_{PROT}50 dyn/cm.

Here, the transfer cylinder 32 is cylindrical; however, the invention is not limited to this. The transfer cylinder 32 may have any form other than a cylindrical one, such as a flat plate-like form.

Next, the ink film 21 formed on the blanket 31 is pressed on the surface of the printing plate 10 mounted on the stage 15 and rolled thereon. Then, the part of the ink film 21 pressed on the non-depressed part 14 of the printing plate 10 is selectively transferred to the said part 14r resulting in a transferred part 21a on the plate 10. This is because the non-depressed part 14 is higher in ink affinity than the blanket 31. On the other hand, the parts of the ink film 21 corresponding to the depressions 13a, 13b, and 13c of the printing plate 10 are not transferred to the plate 10 and as a result, these parts are left on the blanket 31 as non-transferred parts 21b. This is because these parts of the ink film 21 are not pressed on the printing plate 10 due to the existence of the depressions 13a, 13b, and 13c. Alternately, this is because even it these parts of the ink film 21 are pressed on the ink repellent layers 12a, 12b, and 12c covering respectively the inner surfaces of the depressions 13a, 13b, and 13c, they are repelled by the ink repellent layers 12a, 12b, and 12c. In addition, the non-transferred parts 21b thus selectively left on the blanket 31 constitute in its entirety a desired pattern 50 to be printed on the plate 40.

Subsequently, the non-transferred parts 21b of the ink film 21 formed on the blanket 31 are pressed on the surface of the transparent insulative plate 40 (the member for a display device) for the TFT substrate fixed on the stage 15, and rolled thereon. At this time, the starting position of the rolling operation on the transparent insulative plate 40 is matched with the starting position of the rolling operation on the printing plate 10. As a result, the non-transferred parts 21b on the blanket 31 are transferred to the surface of the plate 40. This is because the surf ace of the plate 40 is higher in ink affinity than the blanket 31. In this way, a pattern 50 is formed on the surface of the plate 40 by printing, where the printed pattern 50 is formed by the non-transferred parts 21b thus transferred.

The surface energy E_{BLANKET} of the blanket 31 is determined to be less than the surface energy E_{PLATE} of the transparent insulative plate 40, in other words, to satisfy the relationship of E_{BLANKET}<E_{PLATE}. This is to make the ink affinity of the surface of the plate 40 higher than that of the blanket 31, thereby transferring the non-transferred parts 21b on the blanket 31 to the surface of the plate 40 as desired.

If the surface energy E_{BLANKET} of the blanket 31 is greater than the surface energy E_{PLATE} Of the plate 40, in other words, the relationship of E_{BLANKET}>E_{PLATE} is satisfied, the surf ace of the plate 40 needs to be turned to ink receptive in advance by an appropriate process. As this process, for example, a process of cleaning the surf ace of the plate 40 with hexamethyldisilazane (HMDS) or the like may be used.

In summary, the surface energies of the materials used in the method of fabricating a TFT substrate using the reversed relief offset printing method according to the first embodiment of the invention need to have the following relationships:

In the processes from the formation of the ink film 21 on the blanket 31 to the transfer of the ink film 21 to the printing plate 10, the following conditions (a) to (c) (i.e., the inequality (1) need to be satisfied:

(a) The surface energy E_{REP} of the depressions 13a, 13b, and 13c (i.e., the ink repellent layers 12a, 12b, and 12c) of the printing plate 10 is less than the surface energy E_{INK} Of the ink.

(b) The surface energy E_{INK} of the ink is equal to or less than the surface energy E_{BLANKET} Of the blanket 31.

(c) The surface energy E_{BLANKET} of the blanket 31 is less than the surface energy E_{PROT} of the non-depressed part 14 (i.e., the base material 10a) of the printing plate 10.

The above-described relationships (a) to (c) can be expressed by the inequality (1) below.

E_{REP}<E_{INK}≦E_{BLANKET}<E_{PROT} (1)

In the process of transferring the non-transferred parts 21b of the ink film 21 on the blanket 31 to the transparent insulative plate 40, the following conditions (d) to (f) (i.e., the inequality (2)) need to be satisfied:

(d) The surface energy E_{REP} Of the depressions 13a, 13b, and 13c (i.e., the ink repellent layers 12a, 12b, and 12c) of the printing plate 10 is less than the surface energy E_{INK} of the ink

(e) The surface energy E_{INK} of the ink is equal to or less than the surface energy E_{BLANKET} of the blanket 31.

(f) The surface energy E_{BLANKET} of the blanket 31 is less than the surface energy E_{PLATE} of the transparent insulative plate 40.

The above-described relationships (d) to (f) can be expressed by the inequality (2) below.

E_{REP}<E_{INK}≦E_{BLANKET}<E_{PLATE} (2)

The above-described processes can be used in the formation of a patterned resist film in the fabrication processes of the TFT substrate. In this case, a liquefied resist material is used as the ink. If so, a resist film having a desired pattern is obtained through a single printing process and therefore, the process is simplified compared with the photolithography method that necessitates the complicated processes, such as the formation, exposure, development, and cleaning of a resist film.

Moreover, the above-described processes may be used in the formation of the TFTs, pixel electrodes, insulating layers, and so on during the fabrication of the TFT substrate also.

Concretely speaking, regarding the gate electrodes and the drain electrodes of the TFTs (including the gate lines and the drain lines), for example, ink containing a fine powder of metal dispersed therein is used, where the particle diameter of the powder is on the order of nanometer (nm). It is preferred that the particle diameter of the said powder is, for example, in the range from 1 nm to 60 nm. It is more preferred that the particle diameter of the said powder is on the order of 5 nm.

Regarding the pixel electrodes made of a transparent conductive material, for example, ink containing a fine powder of transparent metal dispersed, such as Indium Tin Oxide (ITO), Indium Zinc Oxide (IZO), or the like, is used. It is preferred that the particle diameter of the said powder is, for example, in the range from 1 nm to 60 nm. It is more preferred that the particle diameter of the said powder is on the order of 5 nm.

Regarding the insulating layers, for example, ink produced by dispersing an insulative resin (e.g., acrylic resin) in an appropriate solvent is used.

In these cases, the gate electrodes and the drain electrodes of the TFTs, and the pixel electrodes each having desired pattern can be obtained through a single printing process. Therefore, the formation processes are significantly simplified compared with the combination of the photolithography method that necessitates the complicated processes (e.g., the formation, exposure, development, and cleaning of a resist film) and the etching method for selectively removing the conductive or insulative films.

With the method of fabricating a substrate for a display device according to the first embodiment of the invention, as described above, since a reversed relief offset printing method that makes it possible to form minute patterns equivalent to those formed by the photolithography method is used, desired minute patterns can be formed with high accuracy. Furthermore, because the printing plate 10 having the above-described structure is used, the “internal omission” in the printed pattern 50 can be prevented. Accordingly, the substrate for a display device (e.g., the TFT substrate) that is likely to induce the “internal omission” and that requires the formation of minute printed patterns with high accuracy can be fabricated surely without casing the “internal omission”.

Moreover, since the “internal omission” in the pattern 50 is avoided without increasing the depths of the depressions 13a, 13b, and 13c of the printing plate 10 with respect to the non-depressed part 14 thereof, the depth of the depressions 13a, 13b, and 13c can be decreased furthermore. For this reason, it is preferred that the depths D of the depressions 13a, 13b, and 13c with respect to the surf ace of the non-depressed part 14 are set at a value in the range from 2 μm to 0.05 μm (i.e., 0.05 μm≦D≦2 μm). It is more preferred that the depths D of the depressions 13a, 13b, and 13c are set at a value in the range from 1 μm to 0.05 μm (i.e., 0.05 μm≦D≦1 μm). If the depths D of the depressions 13a, 13b, and 13c are decreased in such a manner as described here, there are additional advantages that the dimensional accuracy and the shape accuracy are improved in the process of etching the base material 10a of the printing plate 10 to form the depressions 13a, 13b, and 13c, and that the freedom of liberty in designing the dimensions and shapes of the respective parts of the plate 10 is increased. As a result, minute printed patterns can be formed with high accuracy and high flexibility.

The lower limit of the depths D of the depressions 13a, 13b, and 13c is set at 0.05 μm was determined in consideration of the required minimum thicknesses of the ink repellent layers. Specifically, if the depths D of the depressions 13a, 13b, and 13c are less than 0.05 μm, there is a possibility that the depressions 13a, 13b, and 13c whose inner surfaces are respectively covered with the ink repellent layers 12a, 12b, and 12c protrude from the surface of the non-depressed part 14 (i.e., the surface of the base material 10a).

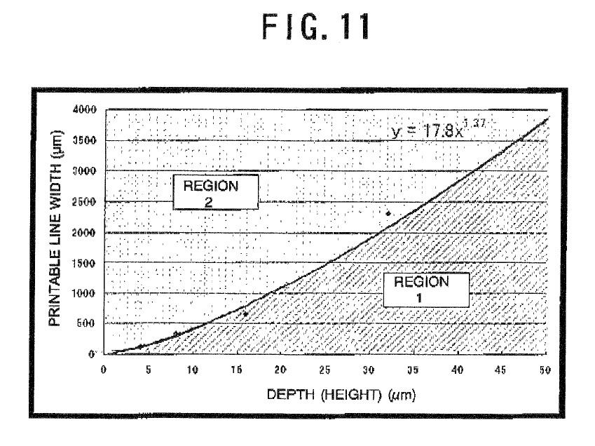

FIG. 11 is a graph showing the relationship between the depth (or height) x (μm) of the depressions 13a, 13b, and 13c of the printing plate 10 with respect to the surface of the base material 10a (i.e., the non-depressed part 14), and the printable line width y (μm) at the depth x. The depth x corresponds to the depths D of the depressions 13a, 13b, and 13c in FIG. 6. In FIG. 11, the boundary for partitioning the region 1 and the region 2 is a curve expressed by the equation of y=17.8×^{1.37}.

The region 2, which is located on the left side of the above-described curve, indicates the range where the line width cannot be printed using the above-described prior-art printing plate, in other words, the printing operation is failed. It was found by the inventor that even if the combination of the depth x and the line width y were placed in the region 2, the printing operation using the printing plate 10 according to the first embodiment of the invention was successful without the “internal omission”.

In addition, with the printing plate 10 according to the first embodiment, the depressions 13a, 13b, and 13c are ink repellent while the non-depressed part 14 is ink receptive. However, the invention is not limited to this. It is sufficient for the invention that the ink repellency of the depressions 13a, 13b, and 13c (i.e., the ink repellent layers 12a, 12b, and 12c) for the printing ink is higher than the ink repellency of the non-depressed part 14 in such a way that the ink film 21 contacted with the printing plate 10 is selectively transferred to the non-depressed part 14, where the ink film 21 is not transferred to the depressions 13a, 13b, and 13c (i.e., the ink repellent layers 12a, 12b, and 12c).

In the above explanation, the Cr film 41 is used as the mask for the formation of the recesses 11a and 11b in the base material 10a; however, it is needless to say that the invention is not limited to this. Any other mask than the Cr film 41 may be used for this purpose if it can be used as such the mask as described here.

FIGS. 17A and 17B schematically show the typical structure of a LCD device as an example of the display device to which the present invention is applied.

As shown in FIGS. 17A and 178, this LCD device comprises a TFT substrate 70 on which TFTs 79 are arranged as the switching elements, a color filter substrate 80 on which a color filter 83 and a black matrix 82 are formed, and a liquid crystal layer 90 sandwiched by the TFT and color filter substrates 70 and 80. The alignment direction of the liquid crystal molecules in the liquid crystal layer 90 is changed, thereby controlling the amount of the transmitted light in each pixel to display desired images.

In the TFT substrate 70, a gate electrode 72 is formed on the surface of a transparent glass plate 71. A gate insulating film 73 is formed on the glass plate 71 to cover the gate electrode 72. An island-shaped amorphous silicon (Si) film 74 is formed on the gate insulating film 73. A source electrode 75 and a drain electrode 76 are formed at each side of the amorphous Si film 74 to overlap with them, forming the TFT 79. A protective insulating film 77 is formed on the gate insulating film 73 to cover the TFT 79. A pixel electrode 78 is formed on the protective insulating film 77. The pixel electrode 78 is in contact with the drain electrode 76 by way of a contact hole of the protective insulating film 77. An alignment film 78a is formed on the protective insulating film 77 to cover the pixel electrode 78.

In the color filter substrate 80, the black matrix 82 and the color filter 83 are formed on the surface of a transparent glass plate 81. An insulating film 84 is formed to cover the black matrix 82 and the color filter 83. A common or opposite electrode 85 is formed on the insulating film 84. An alignment film 85a is formed to cover the opposite electrode 85.

The liquid crystal molecules in the liquid crystal layer 90 are in contact with the alignment films 78a and 85a.

Here, each of the TFT substrate 70 and the color filter substrate 80 is fabricated by the above-described method of fabricating a substrate for a display device according to the first embodiment. However, any one of the TFT and color filter substrates 70 and 80 may be fabricated by this method.

Moreover, the above-described method of fabricating a substrate for a display device according to the first embodiment may be applied to any other type of display devices than the LCD devices such as an organic EL display device, a plasma display device, and so on.

For example, if the present invention is applied to an organic EL display device, TFTs are formed on a substrate serving as an anode by printing and then, organic EL layers for R, G, and B colors are selectively formed in sequence on the same substrate as a color filter by printing, where the above-described method of fabricating a substrate for a display device according to the first embodiment is applied.

### Second Embodiment

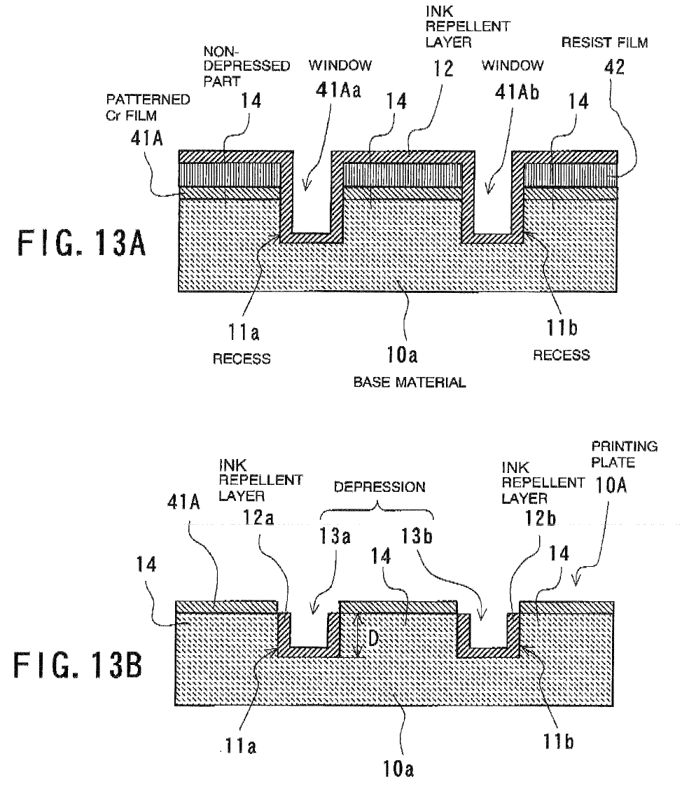

FIG. 13B is a schematic partial cross-sectional view of a printing plate 10A according to a second embodiment of the present invention.

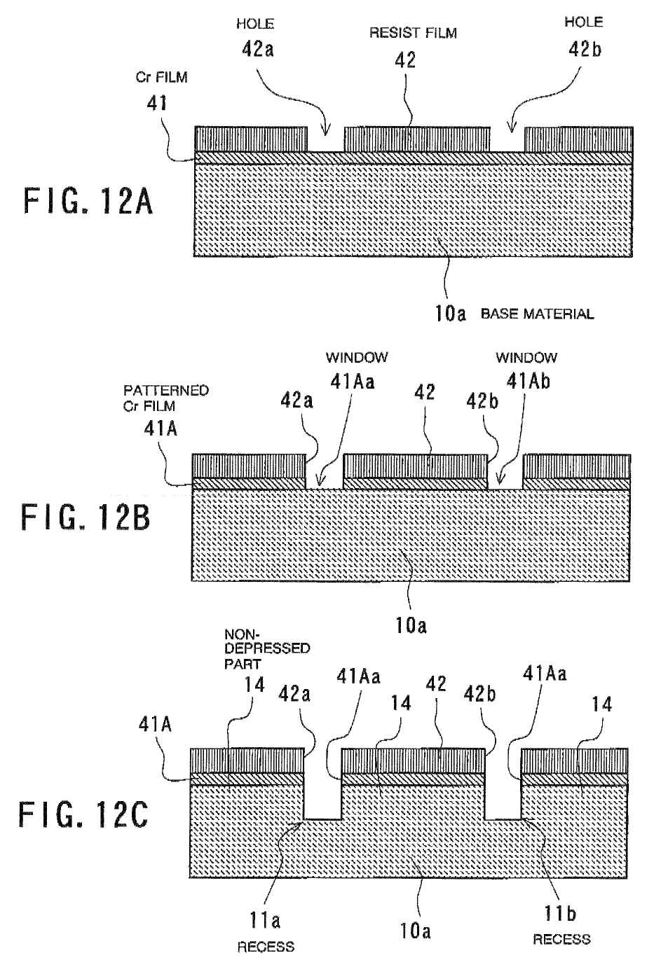

The printing plate 10A according to the second embodiment is the same in structure as the printing plate 10 according to the first embodiment except that the surface of the plate-shaped base material 10a in the region other than the recesses 11a and 11b (i.e., the surface of the non-depressed part 14) is covered with a patterned Cr film 41A. Therefore, the explanation about the same structure is omitted here by attaching the same reference numerals as used in the first embodiment to the same or corresponding elements in FIGS. 12A to 12C and FIGS. 13A and 13B.

With the printing plate 10A of the second embodiment, the surface of the non-depressed part 14 of the base material 10a is covered with the patterned Cr film 41A and therefore, the ink receptive surface of the material 10a is not exposed. However, the Cr film 41A is ink receptive and at the same time, the ink affinity of the Cr film 41A is higher than that of the base material 10a (i.e., glass). Therefore, similar to the printing plate 10 according to the first embodiment, the recesses 11a and 11b (i.e., the ink repellent layers 12a and 12b) are ink repellent while the non-depressed part 14 is ink receptive. Accordingly, the same advantage as those of the plate 10 according to the first embodiment are obtained.

In addition, since the ink affinity of the Cr film 41A is higher than that of glass, there is an additional advantage that the ink film 21 is transferred to the non-depressed part 14 (i.e., the Cr film 41A) more easily than the plate 10 according to the first embodiment.

Since the Cr film 41A is higher detergency than glass, the surface energy of the Cr film 41A can be always kept at 50 to 60 dyn/cm or higher. Therefore, compared with the printing plate 10 according to the first embodiment where the surface of the non-depressed part 14 of the base material 10a is exposed, the printing plate 10A according to the second embodiment has another additional advantage that higher endurance against the repetitive use is obtained.

Next, a method of fabricating the printing plate 10A according to the second embodiment is explained below with reference to FIGS. 12A to 12C and FIGS. 13A and 138. These figures are schematic partial cross-sectional views showing the process steps of this method, respectively.

First, a Cr film 41 is formed on the surface of the plate-shaped base material 10a in the same manner as the first embodiment.

Next, a resist film 42 is formed on the Cr film 41 and thereafter, the resist film 42 is patterned in the same manner as the first embodiment. As a result, penetrating holes 42a and 42b are formed in the resist film 42. The state at this stage is shown in FIG. 12A.

The Cr film 41 is shown here as an example and therefore, it is needless to say that any other metal film than Cr may be used instead of the Cr film 41.

Next, the Cr film 41 is selectively etched using the patterned resist film 42 as a mask (a second mask) in the same manner as the first embodiment. Thus, windows 41Aa and 41Ab are formed in the Cr film 41, as shown in FIG. 12B. In this way, a patterned Cr film 41A (a first mask) is obtained. The windows 41Aa and 41Ab of the Cr film 41A are located at the positions right below the holes 42a and 42b of the resist film 42, respectively.

Subsequently, the surface of the base material 10a is selectively etched using the patterned Cr film 41A as a mask in the same manner as the first embodiment while leaving the resist film 42 as it is, thereby forming recesses 11a and 11b each having a predetermined depth, as shown in FIG. 12C. The plan shapes of the recesses 11a and 11b are approximately the same as the plan shapes (e.g., rectangular) of the holes 42a and 42b, respectively.

Next, an ink repellent layer 12 is formed on the patterned Cr film 41A to cover the surface of the base material 10a having the recesses 11a and 11b while leaving the resist film 42 and the Cr film 41A as they are. At this time, as shown in FIG. 13A, the exposed surface of the resist film 42, the exposed inner surfaces (inner bottoms and inner sides) of the recesses 11a and 11b, and the end faces of the resist film 42 and the Cr film 41A exposed laterally toward the recesses 11a and 11b are covered with the ink repellent layer 12.

The ink repellent layer 12 is formed by the same ink repellent material as used in the first embodiment. Therefore, the surface energy E_{REP} Of the ink repellent layer 12 is less than the surface energy E_{INK} of the printing ink, in other words, the relationship of E_{REP}<E_{INK} is satisfied.

Finally, the resist film 42 in the state of FIG. 13A is detached and as a result, the part of the ink repellent layer 12 placed on the resist film 42 is removed along with the resist film 42. Only the parts 12a and 12b of the ink repellent layer 12 existing in the recesses 11a and 11b are left as they are. For this reason, as shown in FIG. 13B, only the inner surfaces of the recesses 11a and 11b of the base material 10a are respectively covered with the ink repellent layers 12a and 12b.

On the other hand, the state of the base material 10a in the region other than the recesses 11a and 11b (i.e., the non-depressed part 14) is maintained, where the remaining surface of the base material 10a is covered with the Cr film 41A. Accordingly, with the printing plate 10A according to the second embodiment, the ink affinity of the non-depressed part 14 is given by the Cr film 41k, not by the base material 10a.

Through the above-described processes, the printing plate 10A according to the second embodiment is fabricated.

With the printing plate 10A according to the second embodiment, as explained above, unlike the first embodiment, the ink affinity of the non-depressed part 14 is given by the Cr film 41A and therefore, it is unnecessary that the base material 10a has an ink affinity. Accordingly, an additional advantage that the selectable range of the material for the base material 10a is wider is obtained.

Because a method of fabricating a substrate for a display device using the printing plate 10A according to the second embodiment is the same as that using the printing plate 10 according to the first embodiment, the explanation for this method is omitted here.

### Third Embodiment

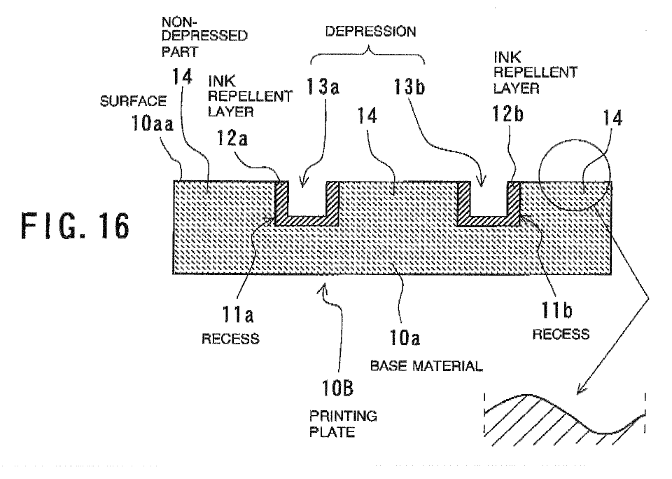

FIG. 16 is a schematic partial cross-sectional view of a printing plate 10B according to a third embodiment of the present invention.

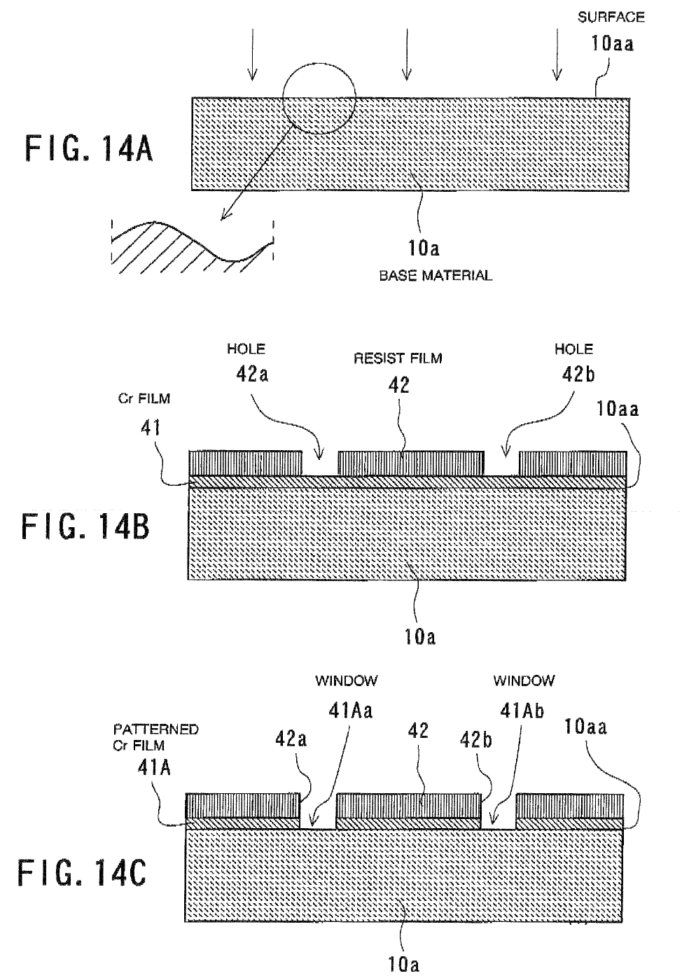

The printing plate 10B according to the third embodiment is the same in structure as the printing plate 10 according to the first embodiment except that the flat surface 10aa of the plate-shaped base material 10a in the region other than the recesses 11a and 11b (i.e., the flat surface of the non-depressed part 14) is roughened by minute bumps and dips. Therefore, the explanation about the same structure is omitted here by attaching the same reference numerals as used in the first embodiment to the same or corresponding elements in FIGS. 14A to 14B, FIGS. 15A to 15C, and FIG. 16.

With the printing plate 10A of the third embodiment, since the surface 10aa of the non-depressed part 14 is roughened, the ink affinity of the non-depressed part 14 is higher than that of the printing plate 10 according to the first embodiment where the surface of the non-depressed part 14 of the base material 10a is not roughened. Accordingly, an additional advantage that the ink film 21 is selectively transferred to the non-depressed part 14 more easily than the printing plate 10 according to the first embodiment is obtained.

Next, a method of fabricating the printing plate 108 according to the third embodiment is explained below with reference to FIGS. 14A to 14C, 15A to 15C, and 16. These figures are schematic partial cross-sectional views showing the process steps of this method, respectively.

First, as shown in FIG. 14A, minute bumps and dips are given to the flat surface 10aa of the plate-shaped base material 10a by a wet etching, dray etching, or sandblasting method, thereby roughening the whole surface 10aa. It is preferred that the minute bumps and dips are smaller than the line widths in the desired pattern 50 to be printed. For example, it is preferred that the distances between the tops of the bumps and the bottoms of the dips are equal to or less than 500 nm.

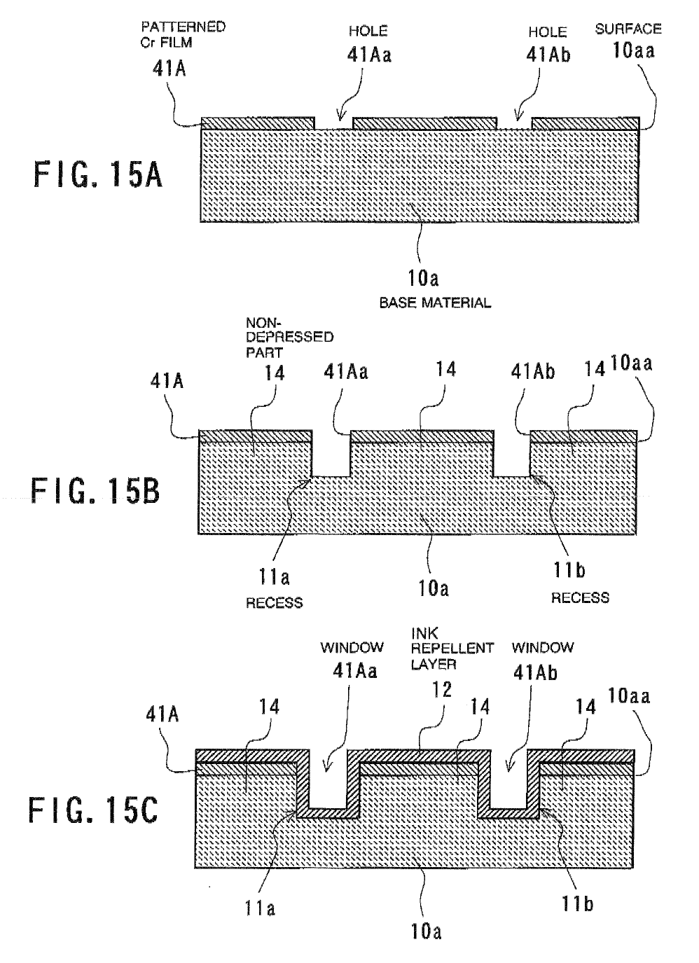

The subsequent processes of this method are the same as those of the first embodiment. Specifically, after a Cr film 41 is formed on the roughened surface 10aa of the base material 10a, a resist film 42 is formed on the surface 10aa and then, the resist film 42 is patterned. In this way, as shown in FIG. 14B, penetrating holes 42a and 42b are formed in the resist film 42. Next, the Cr film 41 is selectively etched using the patterned resist film 42 as a mask, thereby forming windows 41Aa and 41Ab in the Cr film 41, as shown in FIG. 14C. Thereafter, the resist film 42 is removed. The state at this time is shown in FIG. 15A.

Following this, the roughened surface 10aa of the base material 10a is selectively etched using the patterned Cr film 41A as a mask, thereby forming recesses 11a and 11b each having a predetermined depth on the surface of the material 10a, as shown in FIG. 15B.

Next, an ink repellent layer 12 is formed on the patterned Cr film 41A to cover the surface of the base material 10a having the recesses 11a and 11b, where the Cr film 41A is left as it is. As a result, as shown in FIG. 15C, the exposed surface of the Cr film 41A, the exposed inner surfaces (inner bottoms and inner sides) of the recesses 11a and 11b, and the end faces of the Cr film 41A exposed laterally toward the recesses 11a and 11b are covered with the ink repellent layer 12.

Finally, the Cr film 41A in the state of FIG. 15C is removed and as a result, the part of the ink repellent layer 12 placed on the Cr film 41A is removed along with the Cr film 41A. At the same time, only the parts 12a and 12b of the ink repellent layer 12 existing in the recesses 11a and 11b are left as they are. For this reason, as shown in FIG. 16, only the inner surfaces of the recesses 11a and 11b of the base material 10a are respectively covered with the ink repellent layers 12a and 12b while the roughened surf ace 10aa of the base material 10a is exposed in the region other than the recesses 11a and 11b (i.e., in the non-depressed part 14). In this way, the printing plate 10B according to the third embodiment is fabricated.

A method of fabricating a substrate for a display device using the printing plate 10B according to the third embodiment is the same as that using the printing plate 10 according to the first embodiment. Therefore, the explanation for this method is omitted here.

### VARIATIONS

The above-described first to third embodiments are preferred examples of the present invention. Therefore, needless to say, the present invention is not limited to these embodiments and any modification is applicable to them.

For example, a method of fabricating the TFT substrate of the LCD device using a reversed relief offset printing method is explained in the above-described first to third embodiments. However, this method is applicable to the case of fabricating the color filter substrate thereof. Moreover, this method is applicable to the case of fabricating any other substrate for a display device than the TFT and color filter substrates.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A printing plate comprising:
a base material having depressions and a non-depressed part on a surface thereof; and
ink repellent layers that cover inner surfaces of the depressions, respectively;
wherein the depressions of the base material whose inner surfaces are respectively covered with the ink repellent layers have a plan shape that defines a desired pattern, and
the non-depressed part of the base material is formed in such a way that a part of an ink film corresponding to the non-depressed part can be transferred to the non-depressed part in a process of reversed relief offset printing.

2. The printing plate according to claim 1, wherein the depressions have depths in a range from 2 μm to 0.05 μm.

3. The printing plate according to claim 1, wherein the depressions have depths in a range from 1 μm to 0.05 μm.

4. The printing plate according to claim 1 wherein the base material has an ink affinity and is exposed in the non-depressed part.

5. The printing plate according to claim 1, wherein the non-depressed part of the base material is covered with a metal film having an ink affinity.

6. The printing plate according to claim 1, wherein a surface of the non-depressed part of the base material is roughened.

7. The printing plate according to claim 1, wherein the ink repellent layers are formed by a fluororesin for coating made of polytetrafluoroethylene (PTFE), or a silicone resin.

8. The printing plate according to claim 1, wherein the ink repellent layers have a surface energy of 18 dyn/cm or lower.

9. A method of fabricating a printing plate to be used in reversed relief offset printing, which comprises the steps of:
forming a first mask on a surface of a base material;
selectively removing the surface of the base material using the first mask, thereby forming depressions on the surface of the base material;
forming a first layer for ink repellent layers on or over the surface of the base material where the depressions have been formed, the first layer being placed directly on the first mask or over the first mask with intervention of a second mask; and
selectively removing the first layer by removing the first or second mask in such a way that the remaining first layer is placed in the depressions, thereby covering inner surfaces of the depressions with the ink repellent layers, respectively; the ink repellent layers being formed by the remaining first layer;
wherein the depressions of the base material whose inner surfaces are respectively covered with the ink repellent layers have a plan shape that defines a desired pattern.

10. The method according to claim 9, wherein the ink repellent layers are formed directly on the surface of the base material where the depressions have been formed without using the second mask; and
the first layer is selectively removed by removing the first mask.

11. The method according to claim 9, wherein the ink repellent layers are formed over the surface of the base material where the depressions have been formed with intervention of the second mask; and
the first layer is selectively removed by removing the second mask, and the non-depressed part is covered with the first mask.

12. The method according to claim 9, wherein the step of roughening the surface of the base material is carried out before the first mask is formed on the surface of the base material.

13. A method of fabricating a substrate for a display device, comprising;
the step of forming a desired pattern on a member for a display device by a reversed relief offset printing method using the printing plate according to claim 1.

14. The method according to claim 13, wherein a surface energy E_{REP} of the ink repellent layers, a surface energy E_{PROT} of the non-depressed part, and a surface energy E_{INK} of an ink used for printing are determined to satisfy a relationship of
E_{REP}<E_{INK}<E_{PROT}.

15. The method according to claim 14, wherein the surface energy E_{REP} Of the ink repellent layers, the surface energy E_{PROT} of the non-depressed part, and the surface energy E_{INK} of the ink are determined to satisfy the relationships of
E_{REP}≦18 dyn/cm,
20 dyn/cm≦E_{INK}≦24 dyn/cm, and
E_{PROT}≧50 dyn/cm.

16. The method according to claim 13, wherein a surface energy E_{REP} of the ink repellent layers, a surface energy E_{PROT} Of the non-depressed part, a surface energy E_{INK} Of an ink used for printing, and a surface energy E_{BLANKET} of a blanket used for printing are determined to satisfy a relationship of
E_{REP}<E_{INK}≦E_{BLANKET}<E_{PROT}.

17. The method according to claim 16, wherein the surface energy E_{REP} of the ink repellent layers, the surface energy E_{PROT} of the non-depressed part, the surface energy E_{INK} of the ink, and the surface energy E_{BLANKET} of the blanket are determined to satisfy the relationships of
E_{REP}≦18 dyn/cm,
20 dyn/cm≦E_{INK}≦24 dyn/cm,
18 dyn/cm≦E_{BLANKET}≦30 dyn/cm, and
E_{PROT}÷50 dyn/cm.

18. The method according to claim 13, wherein a surface energy E_{REP} Of the ink repellent layers, a surface energy E_{INK} of an ink used for printing, a surf ace energy E_{BLANKET} of the blanket, and a surface energy E_{PLATE} of the member for a display device on which the printed pattern is to be formed are determined to satisfy a relationship of
E_{REP}<E_{INK}≦E_{BLANKET}<E_{PLATE}

19. The method according to claim 18, wherein the surface energy E_{REP} of the ink repellent layers, the surface energy E_{INK} of the ink, and the surface energy E_{BLANKET} of the blanket are determined to satisfy the relationships of
E_{REP}≦18 dyn/cm,
20 dyn/cm≦E_{INK}≦24 dyn/cm, and
18 dyn/cm≦E_{BLANKET}≦30 dyn/cm.

20. The method according to claim 13, wherein a patterned mask is formed on the member for a display device by reversed relief offset printing using ink containing a resist material.

21. The method according to claim 13, wherein a patterned conductive film is formed on the member for a display device by reversed relief offset printing using ink containing a conductive fine powder.

22. The method according to claim 13, wherein a patterned insulative film is formed on the member for a display device by reversed relief offset printing using ink containing an insulative resin.

23. A method of fabricating a display device, comprising:
the step of forming a desired pattern on a substrate for a display device by a reversed relief offset printing method using the printing plate according to claim 1.
